(19) United States
(12) Patent Application Publication
(10) Pub. No.: US 2008/0316615 A1
(43) Pub. Date: Dec. 25, 2008

(54) Image capturing device and method for compensating light attenuation of same

(75) Inventors: Chieh-Jung Hsieh, Tu-Cheng (TW); Ching-Feng Lin, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/953,697

(22) Filed: Dec. 10, 2007

(30) Foreign Application Priority Data
Jun. 25, 2007 (CN) 200710200875.6

(51) Int. Cl. G02B 15/14

(52) U.S. Cl. 359/683; 359/738

(57) ABSTRACT

An image capturing device includes a zoom lens system, an image sensor for capturing images, and a compensating system for compensating the light attenuation of the image capturing device caused by the zoom lens system. The compensating system includes a memory unit, a judging unit, and a compensating unit. The memory unit is configured for storing a plurality of compensating expressions associated with predetermined focal lengths of the zoom lens system. The judging unit is configured for determining the focal length of the lens system when the image sensor capturing an image. The compensating unit is used for compensating for the light attenuation of the image capturing device using the compensating expression associated with the focal length determined by the judging unit.

### TECHNICAL FIELD

The present invention relates to an image capturing device and method for compensating light attenuation of the same and, particularly, to an image capturing device with zoom lens system and method for compensating light attenuation of the same.

### DESCRIPTION OF RELATED ART

With the development of optical imaging technology, image capturing devices are widely used in electronic devices, such as digital cameras and mobile phones. Naturally, there is always a demand for better quality pictures.

Lens systems are an important component in these image capturing devices, the quality of the lens system usually determines the quality of images captured by these devices. When light from an object transmits through the lens system, the quantity of light attenuation between the center of the lens system and the edge of the lens system is different. So, in order to improve the quality of images captured by these devices, the devices usually compensate for the attenuation with a preset compensating function. However, if the lens system is a zoom lens system with variable focal length, light attenuation of the lens system is usually compensated for across just a portion of the total focal length range of the zoom lens system.

What is needed, therefore, is an image capturing device which can solve the above problem and light attenuation of the lens system therein can be compensated for accurately.

### SUMMARY

In accordance with one present embodiment, an image capturing device includes a zoom lens system, an image sensor for capturing images, and a compensating system for compensating the light attenuation of the image capturing device caused by the zoom lens system. The compensating system includes a memory unit, a judging unit, and a compensating unit. The memory unit is configured for storing a plurality of compensating expressions associated with predetermined focal lengths of the zoom lens system. The judging unit is configured for determining the focal length of the lens system when the image sensor capturing an image. The compensating unit is used for compensating for the light attenuation of the image capturing device using the compensating expression associated with the focal length determined by the judging unit.

### BRIEF DESCRIPTION OF THE DRAWING

Many aspects of the present image capturing device can be better understood with reference to the following drawings. The components in the drawing are not necessarily drawn to scale, the emphasis instead being placed upon clearly illustrating the principles of the present image capturing device. Moreover, in the drawings, like reference numerals designate corresponding parts throughout the several views.

FIG. 1 is a schematic, functional block diagram of an image capturing device according to a present embodiment.

FIG. 2 is a schematic, functional block diagram of a compensating system for light attenuation of the image capturing device of FIG. 1.

FIG. 3 is a flow chart of a method for compensating light attenuation of the image capturing device.

### DETAILED DESCRIPTION OF THE EMBODIMENTS

Embodiments will now be described in detail below, with reference to the drawings.

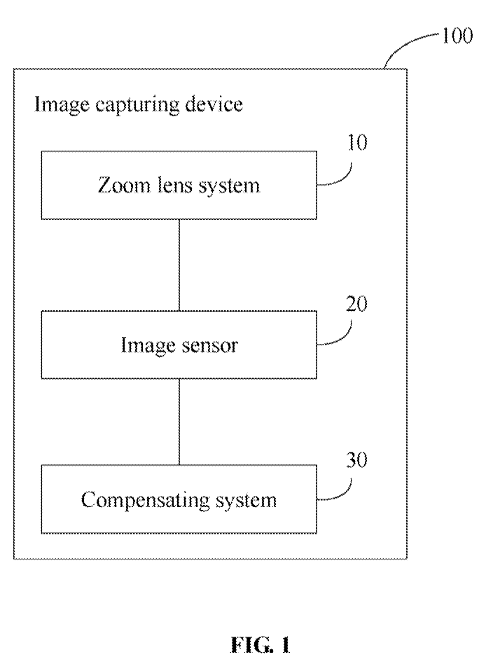

Referring to FIG. 1, an image capturing device 100, according to an embodiment, is shown. The image capturing device 100 includes a zoom lens system 10, an image sensor 20, a compensating system 30. The image capturing device 100 can be a digital camera, a video camera, or a mobile phone with image capturing function.

The zoom lens system 10 can include many lenses capable of being divided into several lens groups.

The image sensor 20 is configured for converting light from an object transmitted through the zoom lens system 10 into digital electrical signals. The image sensor 20 can be a charge-coupled device (CCD) or a complementary metal oxide semiconductor device (CMOS). The image sensor 20 can further be selected from a group consisting of a ceramic leaded chip carrier (CLCC) package type image sensor, a plastic leaded chip carrier (PLCC) package type image sensor, and a chip scale package (CSP) type image sensor.

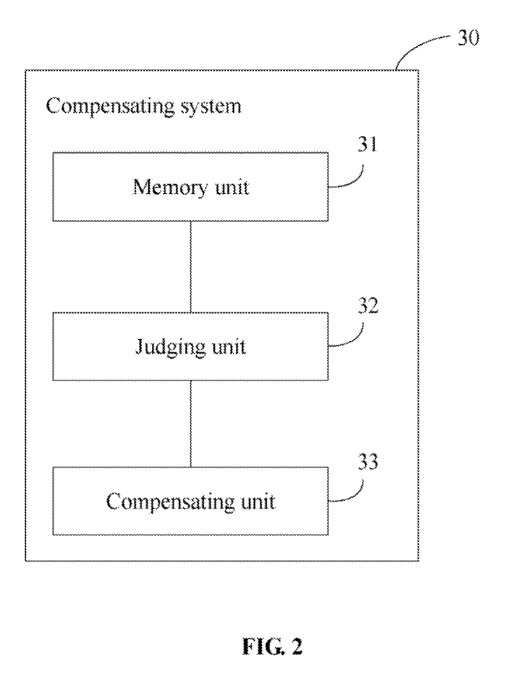

The compensating system 30 is configured for compensating the light attenuation of the image capturing device 100 caused by the lens system 10 by processing the electrical signals output from the image sensor 20. Referring to FIG. 2, the compensating system 30 includes a memory unit 31, a judging unit 32, and a compensating unit 33.

The memory unit 31 is configured for storing a number of compensating expressions associated with different predetermined focal lengths of the lens system 10. The compensating expressions are used for adjusting the electrical signals output from the image sensor 20 in order to improve the quality of images captured by the image capturing device 100. The method of calculating the compensating expressions includes the steps of: capturing an image of an uniform light source using the image capturing device 100 at each predetermined focal length; dividing the image into a number of areas; calculating an average brightness of each area; getting the relationship between the light attenuation at the center of the lens system and at the peripheral edge of the lens system, and determining a compensating expression according to the relationship between the light attenuation at the center of the lens system and at the peripheral edge of the lens system.

The judging unit 32 is configured for determining focal length of the lens system 10 when the image sensor 20 captures an image.

The compensating unit 33 is configured for processing the electrical signals output from the image sensor 20 by using a compensating expression associated with the focal length determined by the judging unit 32 and compensating for the light attenuation of the captured image.

The image capturing device 100 can accurately compensate for light attenuation of images captured by the image capturing device 100 at each predetermined focal length with the corresponding compensating expression.

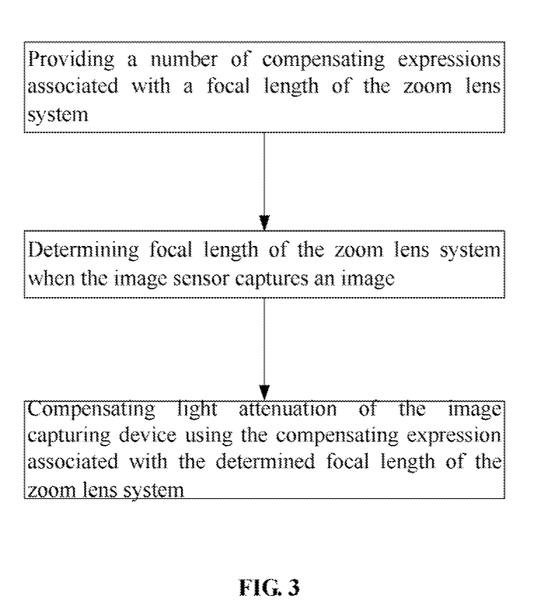

Referring to FIG. 3, a method for compensating light attenuation of the image capturing device 100 is also provided. The method includes the steps of: providing a number of compensating expressions associated with different predetermined focal lengths of the lens system 10; determining focal length of the lens system 10 when the image sensor 20 captures an image; compensating for light attenuation of the image capturing device 100 using the compensating expression associated with the determined focal length.

The method of calculating the compensating expressions includes the steps of: capturing an image of an uniform light source using the image capturing device 100 at each predetermined focal length; dividing the image into a number of areas; calculating an average brightness of each area; getting the relationship between the light attenuation at the center of the lens system and at the peripheral edge of the lens system, and determining a compensating expression according to the relationship between the light attenuation at the center of the lens system and at the peripheral edge of the lens system.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An image capturing device comprising:
a zoom lens system;
an image sensor for capturing images; and
a compensating system for compensating the light attenuation of the image capturing device caused by the zoom lens system, the compensating system comprising:
a memory unit for storing a plurality of compensating expressions associated with a focal length of the zoom lens system;
a judging unit for determining the focal length of the lens system when the image sensor capturing an image; and
a compensating unit for compensating the light attenuation of the image capturing device using the compensating expression.

2. The image capturing device as claimed in claim 1, being selected from a group consisting of a digital camera, a video camera, and a mobile phone.

3. The image capturing device as claimed in claim 1, wherein the image sensor is one of a charge-coupled device and a complementary metal oxide semiconductor device.

4. The image capturing device as claimed in claim 1, wherein the image sensor is selected from a group consisting of a ceramic leaded chip carrier package type image sensor, a plastic leaded chip carrier package type image sensor, and a chip scale package type image sensor.

5. A method of compensating light attenuation of an image capturing device, the image capturing device comprising a zoom lens system and an image sensor, the method comprising the steps of:
providing a number of compensating expressions associated with a focal length of the zoom lens system;
determining focal length of the zoom lens system when the image sensor captures an image; and
compensating light attenuation of the image capturing device using the compensating expression associated with the determined focal length of the zoom lens system.

6. The method as claimed in claim 5, wherein the plurality of compensating expressions is determined by performing the steps of: capturing an image of an uniform light source using the image capturing device at a plurality of predetermined focal lengths; dividing the image into a number of areas; calculating an average brightness of each of the areas; getting the relationship between the light attenuation at the center of the lens system and at the peripheral edge of the lens system, and determining a compensating expression according to the relationship between the light attenuation at the center of the lens system and at the peripheral edge of the lens system.

7. The method as claimed in claim 5, wherein the image capturing device is selected from a group consisting of a digital camera, a video camera, and a mobile phone.
